(19) United States
(12) Patent Application Publication
(10) Pub. No.: US 2020/0056129 A1
(43) Pub. Date: Feb. 20, 2020

(54) Device And Method For Extracting Aroma Substances From Vegetable Aroma Carriers Into A Brewing Liquid

(71) Applicant: GEA BREWERY SYSTEMS GMBH, Kitzingen (DE)

(72) Inventor: LUDWIG SCHELLER, Kitzingen (DE)

(21) Appl. No.: 16/346,682

(22) PCT Filed: Nov. 7, 2017
(86) PCT No.: PCT/EP2017/078404

§ 371 Date: May 1, 2019

(30) Foreign Application Priority Data
Nov. 7, 2016 (DE) 10 2016 121 249.0

(51) Int. Cl. C12C 3/08; C12C 3/12; C12C 7/20; C12C 7/24; C12C 7/28; C12C 11/11

(52) U.S. Cl. CPC C12C 3/085; C12C 3/12; C12C 7/205; C12C 2200/31; C12C 7/287; C12C 11/11; C12C 7/24

(57) ABSTRACT

A device for extracting aroma substances from vegetable aroma carriers into a brewing liquid includes a solids separating device for separating the vegetable aroma carriers from the brewing liquid in flow, the solids of the aroma carriers being held back in the solids separating device. The device comprises a heater for heating the suspension of brewing liquid and aroma carriers to an isomerization temperature at which the α-acids contained in the aroma carriers are converted into iso-α-acids.

The present disclosure relates to a device according to the preamble of claim 1 for extracting aroma substances from vegetable aroma carriers, in particular from solid hop products such as hop pellets, into a brewing liquid. The disclosure further relates to a method for extracting aroma substances from vegetable aroma carriers into a brewing liquid.

Generic devices in the method are employed in the brewing of beer to separate solids of hop products when hopping wort and beer, which may take place at any stage during beer production. This so-called aroma hopping may take place by way of the hot brewing liquid as so-called boil hopping (Ger.: Heiβhopfung) or also after fermentation in the finished beer as so-called dry hopping or hop stuffing (Ger.: Hopfenstopfen).

In beer production, hop is added to the wort during wort production. This is also called boil hopping. In this case, it is one of the tasks of the hop to add a bitter flavor and hop aroma to the beer. Customarily, hop pellets, which contain solids, or hop extract or also natural hop is used for this purpose. In case of hopping in the boiling process, i.e. during the brewhouse process, the hop is usually added during wort boiling. To bring out the hop aroma, the hop may also be added during or after hot trub separation, i.e. in or after the whirlpool and prior to the wort cooler. In this way, the volatile hop aromas are prevented from evaporating and dissipating.

Based on changing customer demands, beer with a strongly pronounced hop aroma is increasingly sought in the market. To achieve said aroma, the beers are increasingly also dry-hopped. This means that hop is added to the beer at the cold stages, preferably after fermentation. This is called dry-hopping. Hop pellets, hop powder or natural hops are most commonly used for this purpose.

When solid hop products, in particular hop pellets, are used, there is the particular disadvantage both at the hot stages and at the cold stages that after extraction of the ingredients, large amounts of residue, so-called spent hops or hop trub particles, remain in the wort and in the beer. These solid residues have to be separated again because they are undesired in the subsequent processes and in the finished beer.

At the hot stages, when the hop is added during wort boiling, said separation subsequently takes place in the whirlpool or by means of a centrifuge, whereby hop trub particles are separated together with the protein residue, namely the hot trub.

In order to achieve proper separation, the whirlpool has to have a sufficiently large separating area so as to be able to receive and separate the hop trub. In case of beers with large amounts of hop, the whirlpool vessels will have to be dimensioned correspondingly larger, which leads to additional investment costs as well as to higher losses of wort.

During hopping, the spent hops are separated by filtration or separation, which, however, causes additional costs because the additional trub particles tend to considerably reduce the capacity and performance of the filter and because it becomes necessary to invest in a potentially custom-built centrifuge. Also, part of the hop trub particles may lie in the fermentation tank in a very compact manner, making them difficult to remove.

From DE 10 2013 101 435 A1, a device and a method for extracting aroma substances from vegetable aroma carriers into a brewing liquid are known. Either a hydrocyclone or a filter, in particular a slotted sieve filter, is used as a solids separating device for separating the insoluble hop trub particles. The use of a hydrocyclone has the disadvantage that adjustment of the capacity of said hydrocyclone to the respectively necessary capacities for hop trub separation is very intricate. Since the hydrocyclone is based on complex flow-mechanical operating principles, the dimensions of the hydrocyclone cannot be easily adjusted or changed depending on the respectively necessary capacity for hop trub separation. The use of a filter for hop trub separation has the disadvantage that these filters, in particular sieve filters, are easily clogged and will have to be laboriously cleaned for continued use.

Field tests have shown that only part of the aroma substances can be transferred into the brewing liquid in the known extraction methods. In particular, the known extraction methods fail to release all releasable aroma substances, in particular the aroma oils contained in the aroma carrier, and to transfer them into the brewing liquid. On the other hand, the known fluidized bed extraction yields insufficient results in transferring and utilizing the bitter substances contained in the aroma substances. Thus, there is always a loss in valuable α-acid, which cannot be used in dry hopping and which so far has been disposed of with the spent hops.

Therefore, the object of the present disclosure is to propose a new device and a new method for extracting aroma substances from vegetable aroma carriers, in particular hop products, into a brewing liquid, by means of which the above-described disadvantages regarding transfer and utilization of bitter substances present in the aroma carriers are avoided.

This object is attained by a device and by a method according to the teaching of the independent claims.

Advantageous embodiments of the disclosure are the subject-matter of the dependent claims.

The disclosure is based on the idea to retrofit the known devices for extracting aroma substances, which use a solids separating device, with a heater by means of which the suspension of brewing liquid and aroma carriers can be heated to an isomerization temperature. This additional option of heating the suspension to the isomerization temperature allows the α-acid contained in the aroma carriers to be converted into iso-α-acid, which is a bitter substance desired in beers. In other words, this means that the additional heat treatment using the added heater increases the formation of iso-α-acids in the suspension of brewing liquid and aroma carriers, allowing these desired bitter substances to be subsequently transferred to the brewing process.

The type of solids separating device used to perform extraction is basically optional. Different solids separating devices are known for this purpose. Extraction using a fluidized bed extractor is particularly effective and economical. The fluidized bed extractor can accommodate a suspension bed formed by the brewing liquid and the solids contained in the aroma carriers. The fluidized bed extractor additionally has at least one inlet and one outlet for the brewing liquid, wherein the brewing liquid can be pumped from the inlet through the fluidized bed extractor to the outlet by means of a feed pump. The feeding speed of the feed pump is set to a value at which the average vertical feeding speed of the brewing liquid in the fluidized bed extractor is lower than the average vertical sedimentation speed of the solid particles in the fluidized bed extractor.

The way in which the heater for heating the suspension is constructively designed is basically optional. The suspension of brewing liquid and aroma carriers can be heated in a particular simple way if a heating element installed on the fluidized bed extractor is used. In this way, the suspension contained in the fluidized bed extractor can be heated by operating the heating element until the isomerization temperature is achieved or exceeded.

As an alternative to the heating of the suspension of brewing liquid and aroma carriers in the fluidized bed extractor, the device can additionally also be retrofitted with a buffer vessel. After extraction of aroma substances, for which the fluidized bed extractor is used, the suspension will be pumped into said buffer vessel, where it can be heated for isomerization and/or cooled after isomerization. The additional buffer vessel allows the sub-process for extracting aroma substances on the one hand, which is carried out in the fluidized bed extractor, and the sub-process for isomerizing the iso-α-acids in the buffer vessel on the other hand to be carried out separately and to be decoupled. Also, the use of the buffer vessel makes it possible to temporarily store the brewing liquid with the iso-α-acids contained therein as obtained from isomerization.

As an alternative to the heater being installed directly on the fluidized bed extractor or directly on the buffer vessel, separate flow heaters may be used. They may be a heat exchanger, for example, in particular a plate heat exchanger. During heating, the suspension may also flow through the flow heater multiple times and is heated during passage by heat transfer. A suitable heat transfer medium, such as steam or hot water, may be used to heat the flow heater.

Tests have shown that an excessively long exposure to heat during isomerization of the bitter substances on the other hand can cause negative decomposition processes of the bitter substances. Thus, for the isomerization to have optimum success, the temperature has to drop back to below the isomerization temperature after a certain exposure time. To achieve that, the device can additionally be quipped with a cooler. Said cooler then serves to cool the suspension of brewing liquid and aroma carriers to a cooling temperature below the isomerization temperature after isomerization.

The type of the cooler is basically optional. A particularly simple way of cooling the suspension of brewing liquid and aroma carriers uses a cooling element that is installed on the fluidized bed extractor. With regard to a cooling of the suspension being as effective as possible, a flow cooler, such as a heat exchanger, in particular a plate heat exchanger, can again be used. The suspension will be pumped through the flow cooler by means of a pump and will be cooled by heat transfer to a coolant, such as cold water. As the case may be, cold brewing water in the flow cooler can also be heated to the desired brewing water temperature.

The effectiveness of the isomerization process also depends on the isomerization temperature selected in each case. The isomerization is particularly effective if an isomerization temperature in a range higher than 120° C. is selected. However, such high temperatures can only be achieved in the suspension—which is a water-based mixture of liquid and solids—if the isomerization takes place under pressure because otherwise undesired evaporation of the brewing liquid occurs. To allow for isomerization under pressure, it is particularly advantageous if the vessel used for isomerizing the suspension, i.e. the fluidized bed extractor or the buffer vessel, is realized as a pressure vessel.

Furthermore, it is of great importance for the success of the isomerization that the isomerization temperature is distributed as homogeneously as possible in the suspension. To achieve that, it is particularly advantageous if a mixing element by means of which the suspension can be mixed is disposed in the vessel used for isomerization, i.e. in the fluidized bed extractor or in the buffer vessel. The mixing element can be a mechanical mixer, in particular a shear stirrer, or a circulation pump by means of which the suspension can be circulated in the vessel.

To be able to avoid additional installation of a heater, it is also possible for a heater present in the brewhouse anyway to be used for isomerizing the suspension. For this purpose, the heater can be realized in the manner of a brewhouse vessel, in particular in the manner of a wort kettle. In this case, the device comprises a transfer line in which the suspension of brewing liquid and aroma carriers can be pumped into the brewhouse vessel after the extraction of aroma substances. The suspension of brewing liquid and aroma carriers can be boiled together with the wort in the brewhouse vessel for isomerization.

The method according to the disclosure is based on the idea that prior to and/or during and/or after release of the aroma substances in the solids separating device, at least part of the suspension of brewing liquid and aroma carriers is heated to an isomerization temperature at which the α-acids contained in the aroma carriers are converted into iso-α-acids. In other words, this means that the heat treatment of the suspension is carried out prior to the releasing process, during the releasing process or after completion of the releasing process. However, it is particularly preferred for the heat treatment to be carried out by heating the suspension to an isomerization temperature after the releasing process.

Preferably, the method according to the disclosure is carried out using a fluidized bed extractor as the solids separating device.

To avoid negative decomposition processes caused by an excessively long heat treatment of the suspension, it is particularly advantageous if the suspension is cooled to a cooling temperature below the isomerization temperature after a certain isomerization time.

It is particularly advantageous if an additional buffer vessel is used to untangle the processes for releasing the aroma substances by using the fluidized bed extractor on the one hand and to convert the α-acids into the iso-α-acids by heat treatment. After sufficient release of the aroma substances by corresponding processing in the fluidized bed extractor, the suspension can subsequently be pumped into a buffer vessel where it is heated to isomerize the bitter substances or cooled to interrupt the isomerization process.

The process for isomerizing or for interrupting the isomerization is particularly effective if the suspension is heated in flow or is cooled in flow.

Isomerization is particularly effective if an isomerization temperature greater than 100° C., in particular an isomerization temperature greater than 120° C., is selected. To this end, the suspension should be heated under pressure in order to avoid undesired evaporation processes.

To achieve a temperature distribution of the isomerization temperature being as homogenous as possible in the suspension, the suspension should be mixed by a mixing element during heat treatment for isomerization and/or during cooling after completion of the isomerization.

The aroma substances composing the suspension are basically optional. It is particularly advantageous if a hop product is used, in particular hop pellets. When forming the suspension, an alcoholic brewing liquid, in particular fermenting or matured beer, should be used as the brewing liquid.

To be able to avoid additional installation of a heater, it is also possible for a heater present in the brewhouse anyway to be used for isomerizing the suspension. To this end, at least part of the suspension remaining after sufficient release of the aroma substances is pumped into a brewhouse vessel, in particular into a wort kettle. In the brewhouse vessel, the suspension of brewing liquid and aroma carriers is boiled together with the wort for isomerization. A buffer vessel in which the suspension of brewing liquid and aroma carriers can be buffered may also be used in the brewhouse for temporarily storing the suspension.

Thus, there is flexibility of time between the formation of the suspension and its isomerization in the brewhouse vessel.

In the figures:

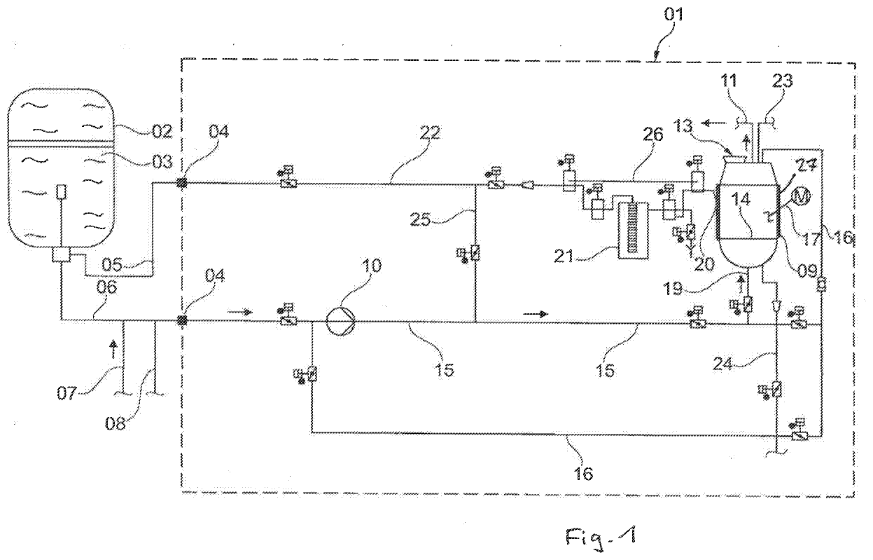

FIG. 1 shows a device for extracting aroma substances at the beginning of the process;

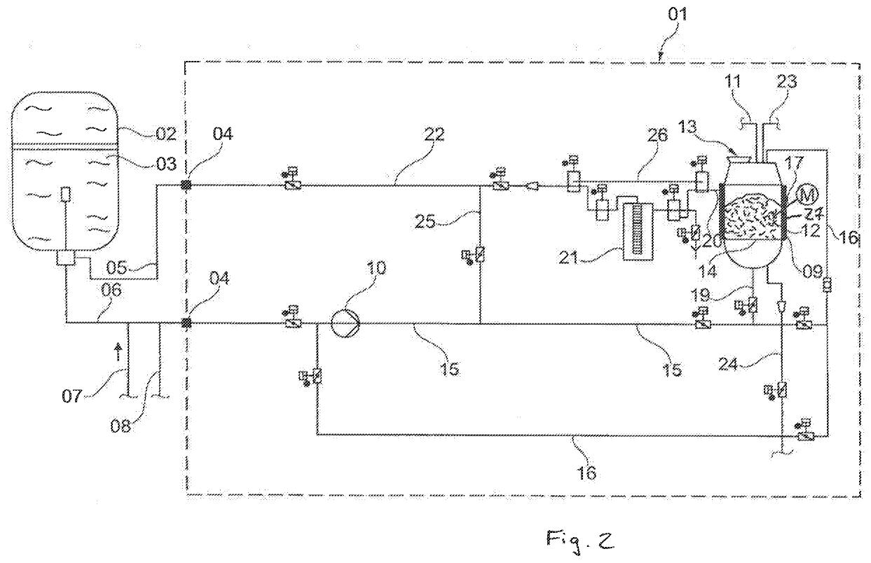

FIG. 2 shows the device according to FIG. 1 during filling of the fluidized bed extractor with hop pellets;

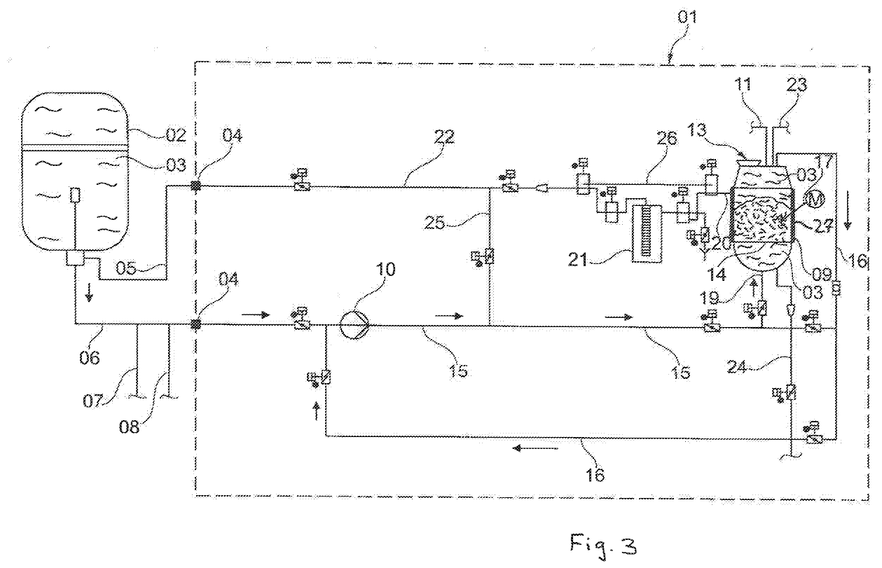

FIG. 3 shows the device according to FIG. 2 during filling of the fluidized bed extractor with beer;

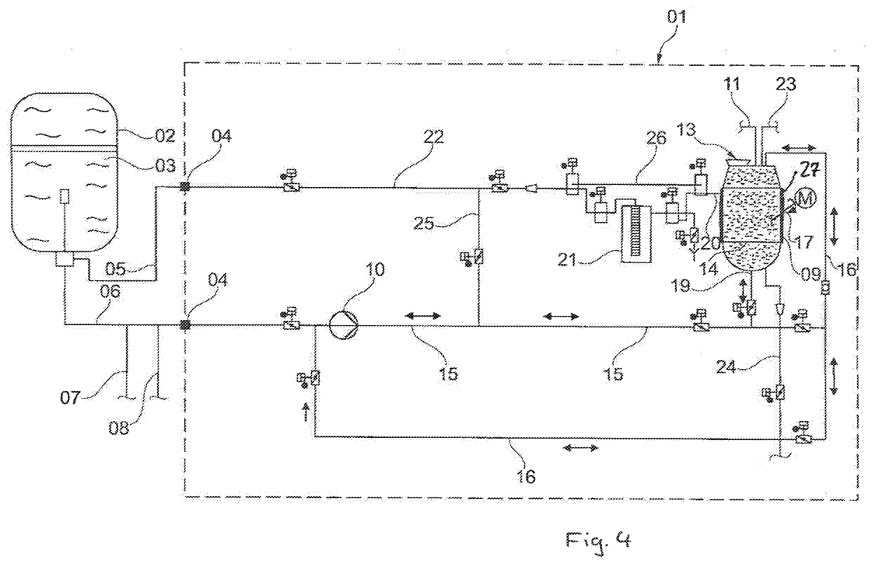

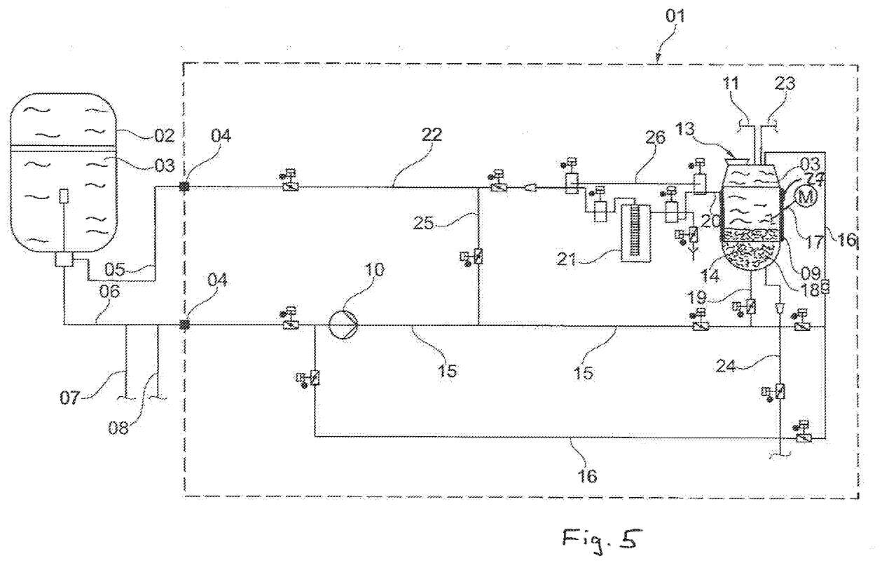

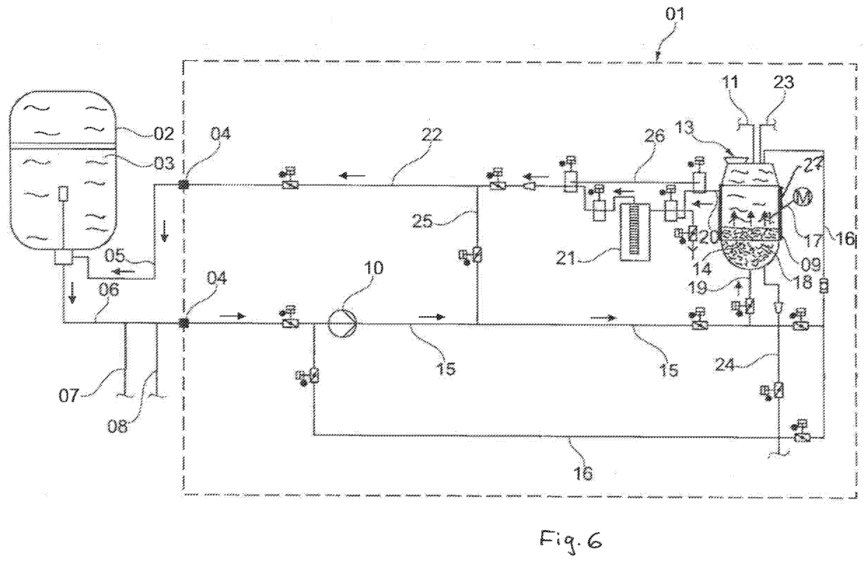

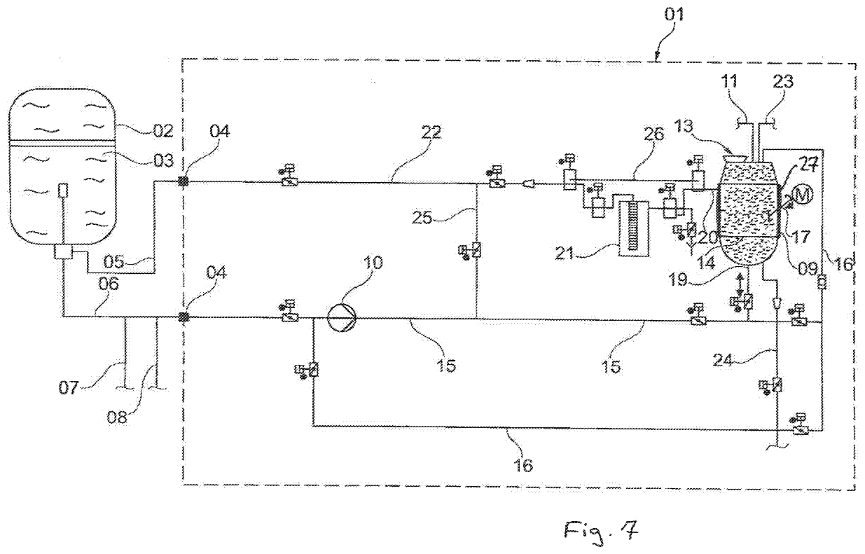

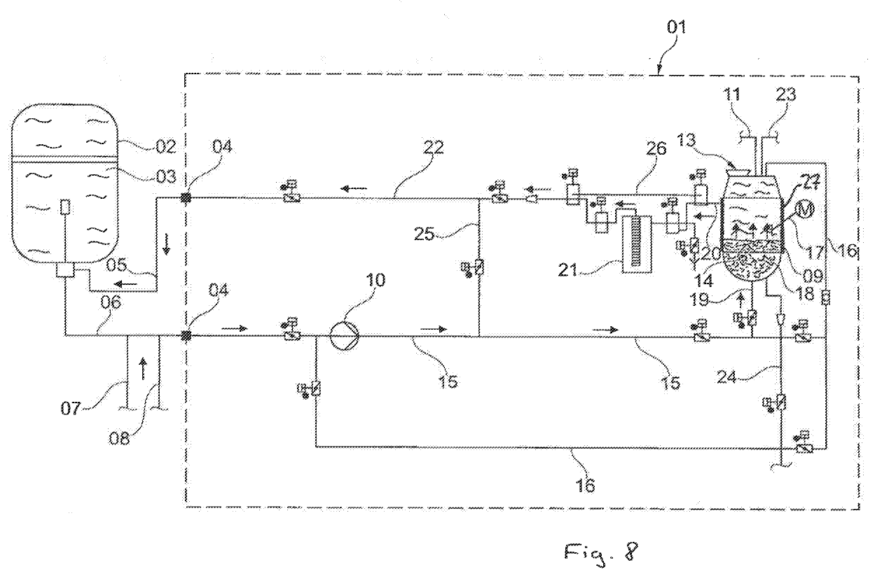

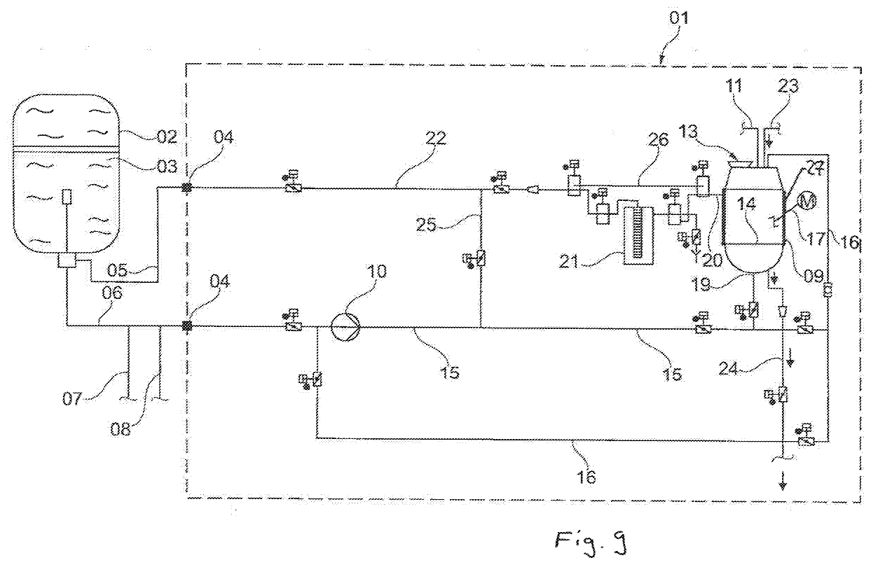

FIG. 4 shows the device according to FIG. 3 during formation of the suspension of beer and hop particles;

FIG. 5 shows the device according to FIG. 4 during sedimentation of the suspension of beer and hop particles at the bottom of the fluidized bed extractor,

FIG. 6 shows the device according to FIG. 5 while brewing liquid is pumped through the fluidized bed extractor to release the soluble aroma substances into the beer;

FIG. 7 shows the device according to FIG. 6 during heating of the remaining suspension of brewing liquid and aroma carriers to the isomerization temperature;

FIG. 8 shows the device according to FIG. 7 during removal of the brewing liquid after isomerization;

FIG. 9 shows the device according to FIG. 8 during removal of the residual suspension from the fluidized bed extractor;

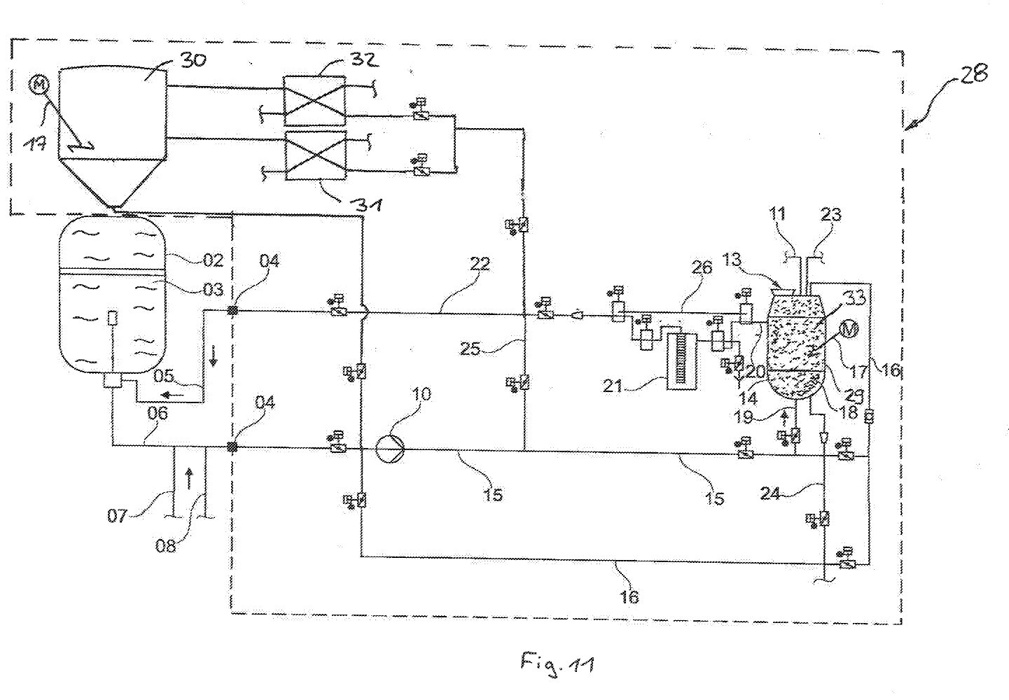

FIG. 10 shows the device according to FIG. 9 during circulation pumping of the beer to homogenize the aroma substance concentration.

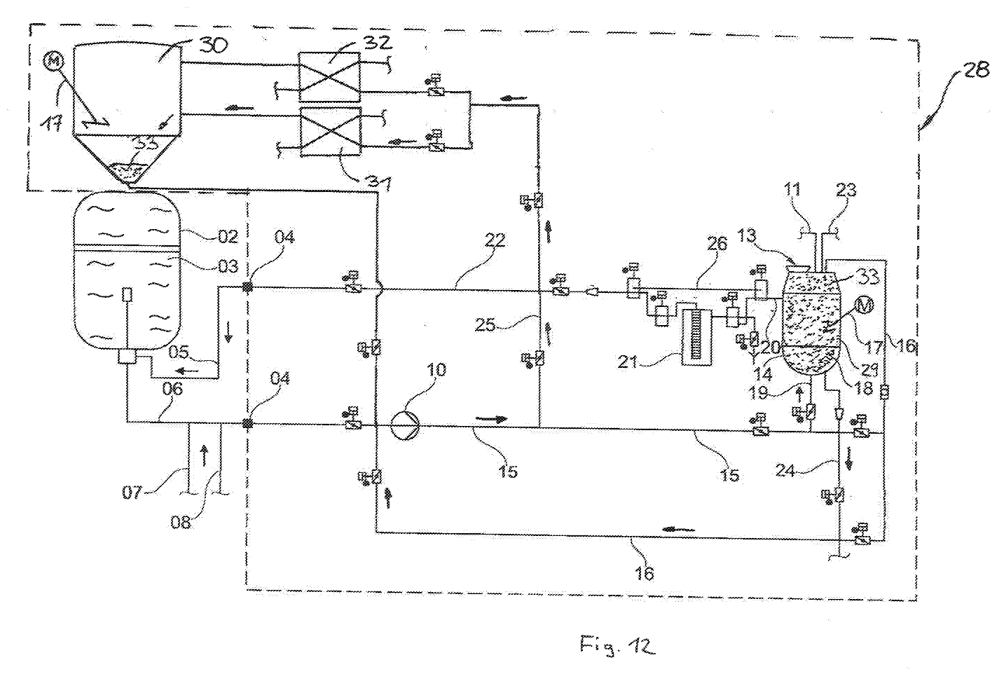

FIG. 11 shows a second embodiment of a device according to the disclosure during formation of the suspension of brewing liquid and aroma carriers after release of the releasable aroma substances by pumping brewing liquid through the fluidized bed extractor;

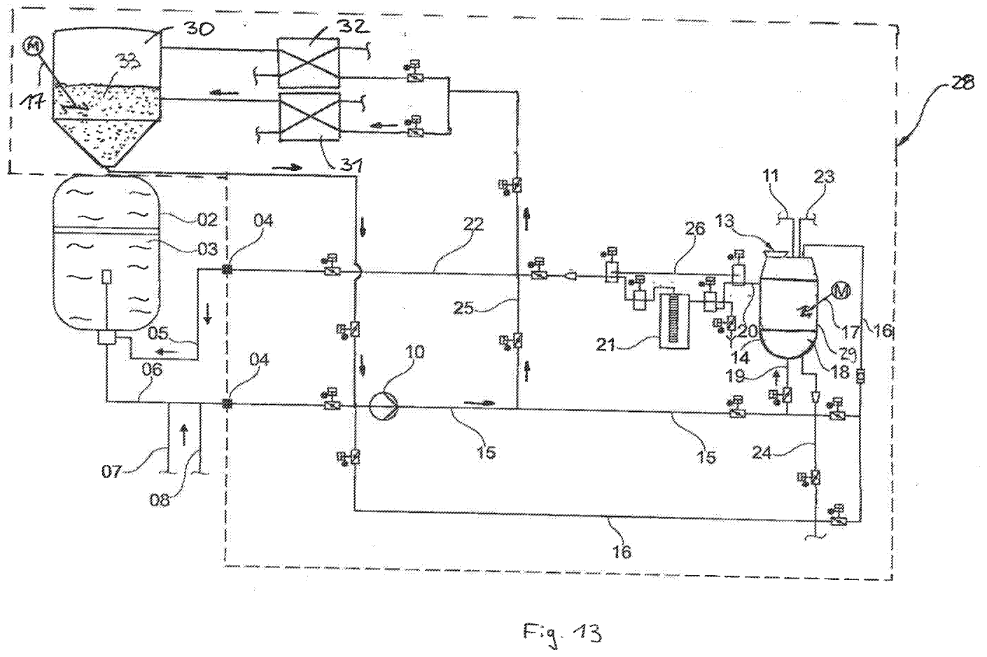

FIG. 12 shows the device according to FIG. 11 during transfer of the suspension into a buffer vessel;

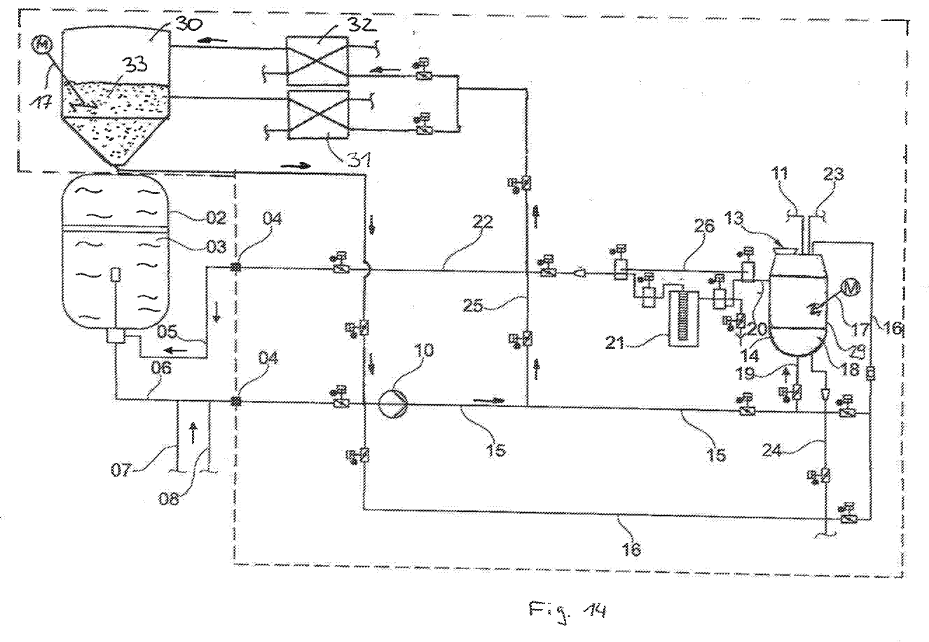

FIG. 13 shows the device according to FIG. 12 during heating of the suspension in the buffer vessel to the isomerization temperature;

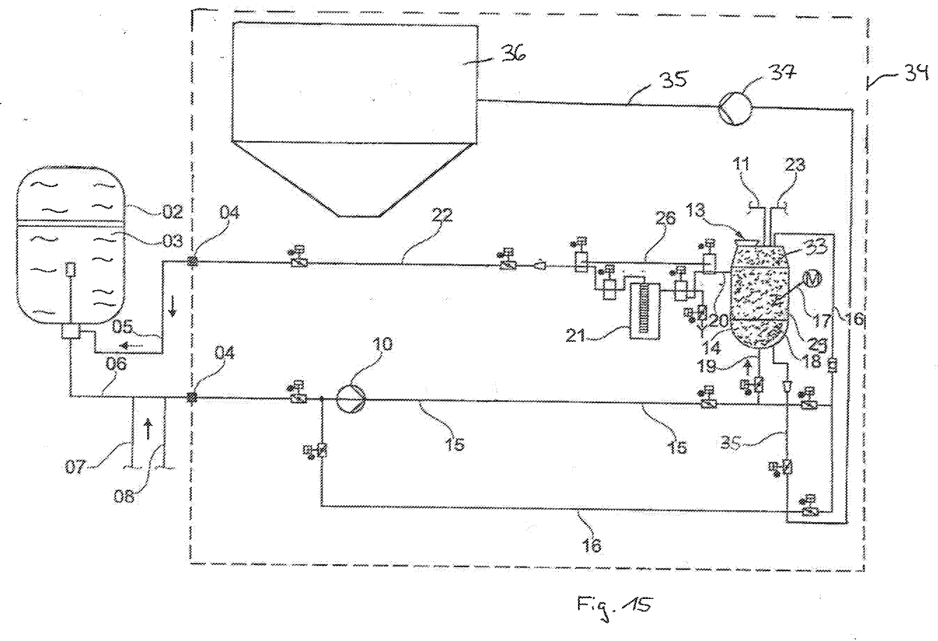

FIG. 14 shows the device according to FIG. 12 during cooling of the suspension in the buffer vessel to a cooling temperature below the isomerization temperature;

FIG. 15 shows a third embodiment of a device according to the disclosure during formation of the suspension of brewing liquid and aroma carriers after release of the releasable aroma substances by pumping brewing liquid through the fluidized bed extractor.

FIG. 1 shows a device 01 according to the disclosure for extracting aroma substances from vegetable aroma carriers, namely hop pellets, into a brewing liquid, namely beer. The device is illustrated merely schematically in FIG. 1, only the components of the device 01 that are necessary for the understanding of the disclosure being illustrated. The device 01 can preferably be mounted on a mobile frame so as to be able to move the device 01 in a mobile manner to different locations of use.

In the variant of use illustrated in FIG. 1, the device 01 is used in a fermentation or storage cellar for dry-hopping beer. First, the device 01 is rolled to a fermentation tank 02, in which matured beer or beer 03 that is still fermenting is stored. The fermentation tank 02 is illustrated only in a miniaturized manner in FIG. 1. Via connection couplings 04, the device 01 is connected to the inlet 05 and to the outlet 06 of the fermentation tank 02. Moreover, a CO₂ supply duct 07 and a brewing water supply duct 08 end in the outlet 06 of the fermentation tank 02. Alternatively, the ducts 07 and 08 can also be guided directly into the device 01. This increases only the number of connections from the brewery into the device 01.

In its core, the device 01 consists of a fluidized bed extractor 09, through which different media can be pumped from various pipes and different check valves by being driven via a controllable feed pump 10. Before the actual process for extraction begins, first, CO₂ from the CO₂ supply duct 07 is fed into the device 01, and the different pipes and the fluidized bed extractor 09 are flooded with CO₂, as illustrated in FIG. 1. At the highest point, the CO₂ can escape from the device 01 via a gas discharge 11.

As soon as the device 01 is flooded with CO₂, first, the fluidized bed extractor is filled with dry hop pellets 12, as illustrated in FIG. 2. Filling takes place via a filling opening 13. When being filled in, the hop pellets come to rest on a permeable support element 14, namely a sieve bottom. The size of the sieve openings is selected in such a manner that the hop pellets 12 cannot drop through the sieve openings. Yet at the same time, liquids can easily flow through the support element 14. The order of the process steps of flooding the system with CO₂ and of filling the extractor with hop pellets can be switched. This does not change the method according to the disclosure in any way.

After filling-in of the hop pellets, the device 01 and in particular the fluidized bed extractor 09 is filled with beer 03. To this end, the beer is pumped by operation of the feed pump 10 out of the fermentation tank 02 through the outlet 06 and the feed line 15 into the fluidized bed extractor 09 from below until the latter is completely filled with beer and the beer flows back to the feed line 15 via a circulation duct 16. The gas contained in the system is removed from the device via the discharge 11.

Once the fluidized bed extractor 09 and the circulation duct 16 are completely flooded with beer, the outlet 06 of the fermentation tank 02 is disconnected from the device 01 by switching a valve and, as illustrated in FIG. 4, the beer is pumped in a circulating manner through the feed line 15 and the circulation duct 16 by the feed pump 10. By circulation-pumping the beer, the pressed hop pellets dissolve in the fluidized bed extractor 09 and a fine suspension of hop particles and beer is formed. To facilitate formation of the suspension, the feeding direction of the feed pump 10 is repeatedly switched and the beer is thus fed through the fluidized bed extractor 09 in alternating feeding directions. Moreover, formation of the suspension can be facilitated by driving a mixing element 17, namely a jet mixer or a shear stirrer.

As soon as the hop pellets 12 are completely crushed and the hop particles contained in the hop pellets form a finely distributed suspension together with the beer 03, the feed pump 10 is briefly turned off, as illustrated in FIG. 5, so that a suspension bed 18 can form at the bottom of the fluidized bed extractor 09. The height of the suspension bed 18 should not exceed half of the height of the fluidized bed extractor 09.

Once the suspension bed 18 has sufficiently settled, the circulation duct 16 is closed and the outlet 06 of the fermentation tank 02 is connected to the device 01 again by opening the corresponding valve. Subsequently, as illustrated in FIG. 6, the beer 03 is pumped from the fermentation tank 02 through the feed line 15 and the inlet 19 into the fluidized bed extractor 09 from below by operation of the feed pump 10. The beer flows vertically upward through the suspension bed 18 and flows toward the outlet 20 of the fluidized bed extractor 09. The feeding speed of the feed pump 10 is selected such that the average vertical flow speed of the beer 03 in the fluidized bed extractor 09 is lower than the average vertical sedimentation speed of the hop particles. With this speed difference, it is achieved that the insoluble solid particles settle at the bottom of the fluidized bed extractor 09 and together form the suspension bed 18. Only very fine solid particles can be transported out of the fluidized bed extractor 09 via the outlet 20 together with the beer 03. To remove these very fine solid particles, the beer subsequently flows through a fine filter device 21, namely a backflushable corner pipe filter. Subsequently, the beer flows toward the inlet 05 of the fermentation tank 02 via the return line 22 of the device 01 and thus returns into the fermentation tank 02. Depending on the desired degree of filtration, the fine filter device 21 may also be bypassed entirely or in part by way of a bypass duct 26. This decision is up to the user.

If it is possible within the parameters of the process, the fine filter device 21 may also be entirely omitted. The fine solid particles would then reach the fermentation tank 02 and would have to be removed from the beer 03 in another way. This decision, too, has to be made by the user in consideration of the intended use.

The circulation of the beer 03 from the fermentation tank 02 as illustrated in FIG. 6 serves to leach the aroma substances from the hop particles contained in the suspension bed 18, sufficient separation of the liquid and solid components of the suspension being provided at the same time by the flow characteristics of the fluidized bed extractor 09.

In general, the process steps for forming the suspension, as illustrated in FIG. 4, and for leaching, as illustrated in FIG. 6, may also be repeated several times so as to further increase leaching by repeatedly whirling up the suspension bed 18. The process step according to FIG. 5 for forming the suspension bed is then performed in each case between the respective process steps for forming the suspension. This process can further increase the degree of leaching.

As soon as a sufficient degree of leaching of the hop particles is reached, the outlet 06 of the fermentation tank 02 is closed.

Then, as illustrated in FIG. 7, a suspension is formed anew in the fluidized bed extractor 09 by driving the mixing element 17. At the same time as the suspension is formed anew, the suspension in the fluidized bed extractor 09 is heated by operating a heating element provided at a wall of the fluidized bed extractor 09. The temperature of the suspension is increased to no more than the evaporation temperature that can be achieved at the current tank pressure. Upon arrival at the isomerization temperature, the α-acids contained in the aroma carriers of the suspension are converted into iso-α-acids. The intensity of the isomerization can be controlled by maintaining the isomerization temperature for a certain time of 20 to 30 minutes, for example.

After isomerization, brewing water from the brewing water supply duct 08 is pressed into the feed line 15, as illustrated in FIG. 8, so as to press the beer remaining in the device 01 with the iso-α-acids contained therein back into the fermentation tank 02 via the return line 22 and the inlet 05 of the fermentation tank 02. Additionally, the content of the fluidized bed reactor can be cooled again beforehand by means of a cooler (not illustrated).

Once the beer 03 has been completely removed from the device 01, a suitable cleaning fluid, preferably brewing water 08, is pressed into the fluidized bed extractor 09 via a duct 23, as illustrated in FIG. 9, and the remaining residual suspension is discharged via an outlet duct 24 in the direction of a drain duct (not illustrated). Subsequently, the entire installation can be machine-cleaned by means of a CIP cleaning device not illustrated in the drawing.

To homogenize the concentration of the aroma substances dissolved in the beer 03, the beer 03 can be pumped through a circulation duct 25 and can be mixed by operation of the feed pump 10 in the fermentation tank 02, as illustrated in FIG. 10.

FIG. 11 shows a second embodiment 28 for extracting aroma substances from vegetable aroma carriers. The device 28 differs from the device 01 only in that, unlike in the case of the fluidized bed extractor 09, no heating element is provided on the fluidized bed extractor 29 of the device 28. Instead, the device 28 is additionally equipped with a buffer vessel 30, upstream of which a heater 31 and a cooler 32 are disposed. The heater 31 is realized in the manner of a flow heater, such as in the manner of a plate heat exchanger, and can be heated with hot steam or hot water. Heating takes place by heat transfer without the heating medium mixing with the process medium. The cooler 32 is realized as a flow cooler, for which a plate heat exchanger can be used, as well. Said plate heat exchanger can be cooled by heat transfer to cold water, in particular cold brewing water.

The process state of the device 28 as illustrated in FIG. 11 corresponds to the process state of the device 01 as illustrated in FIG. 7. That is, the release of the aroma substances from the aroma carriers using the fluidized bed extractor 29 has been completed. Afterwards, the solids are distributed evenly in the brewing liquid by operating the mixing element 17.

FIG. 12 now shows how the suspension 33 contained in the fluidized bed extractor 29 is pumped into the buffer vessel 30 by driving the pump 10 and by suitably switching the check valves. The suspension 33 passes through the heater 31 and is heated, whereas the cooler 32 is closed.

FIG. 13 shows the device 28 after the fluidized bed extractor 29 has been completely emptied and the entire remaining suspension 33 is located in the buffer vessel 30. In order to now heat the suspension 33 to the desired isomerization temperature of 120° C., for example, the suspension is pumped through the heater 31 by driving the pump 10 and by suitably switching the check valves in the circuit, the suspension being continuously heated in the process. Once the desired isomerization temperature greater than 120° C. has been achieved, it is maintained for a predefined isomerization time of 20 minutes, for example. In order to prevent evaporation of the water content in the suspension 33, the isomerization in the buffer vessel 30 takes place under pressure.

FIG. 14 shows the device 28 after the predefined isomerization time of, for example, 20 minutes at 120° C. has passed. In order to avoid undesired sub-processes caused by even longer heat treatment, the suspension is then pumped through the cooler 32 by operating the pump 10 and suitably switching the passage valves as shown in FIG. 14, the suspension thus being quickly cooled to a cooling temperature of 70° C., for example, further isomerization thus being halted. The heat treatment and cooling process illustrated in FIG. 11 to FIG. 14 causes the α-acids contained in the suspension 33 to be converted into the iso-α-acids desired for the production of beer. After completion of the cooling of the suspension illustrated in FIG. 14, the solids present in the suspension can be filtered to allow suitable further use of the brewing liquid with the iso-α-acids contained therein. To filter the solids, the suspension can be pumped from the buffer vessel 30 back into the fluidized bed extractor 29, for example, and can then be filtered according to the process as shown in FIG. 8. Of course, other filtration methods for filtering the solids from the brewing liquid in the suspension 33 contained in the buffer vessel 30 are possible, as well.

In the two illustrated embodiments of the disclosure, the isomerized content of the fluidized bed extractor or of the buffer vessel was introduced into the fermentation tank. Of course, the content can also be introduced into any vessel or at any point in the brewhouse (such as into the wort kettle). Alternatively or additionally to the hop addition, the suspension can also be used during wort production. Further buffering in another buffer vessel is possible, as well, because this allows better buffering of delays between production of the isomerized suspension and its use. This use in the brewhouse, too, saves costs in connection with the addition of bitter substances during beer production.

FIG. 15 shows a third embodiment 34 for extracting aroma substances from vegetable aroma carriers. The device 34 again differs from the device 01 in that, unlike in the case of the fluidized bed extractor 09, no heating element is provided on the fluidized bed extractor 29 of the device 34. Instead, the fluidized bed extractor 29 of the device 34 is connected to a brewhouse vessel 36 via a transfer line 35. The heaters of the brewhouse vessel 36, in which wort is boiled, are not illustrated in FIG. 15.

The process state of the device 34 as illustrated in FIG. 15 corresponds to the process state of the device 01 as illustrated in FIG. 7. That is, the release of the aroma substances from the aroma carriers using the fluidized bed extractor 29 has been completed. Afterwards, the solids are distributed evenly in the brewing liquid by operating the mixing element 17.

Then, by operating a pump 37 and by suitably switching the check valves, the suspension 33 contained in the fluidized bed extractor 29 is pumped into the brewhouse vessel 36, where it is mixed with wort which is yet to be boiled. The suspension 33 is then heated and isomerized during wort boiling in the brewhouse vessel 36.

1. A device for extracting aroma substances from vegetable aroma carriers into a brewing liquid, in particular into beer, comprising a solids separating device for separating the vegetable aroma carriers from the brewing liquid in flow, the solids of the aroma carriers being held back in the solids separating device, wherein the device comprises a heater for heating the suspension of brewing liquid and aroma carriers to an isomerization temperature at which the α-acids contained in the aroma carriers are converted into iso-α-acids.

2. The device according to claim 1, wherein the solids separating device is realized in the manner of a fluidized bed extractor, said fluidized bed extractor being able to accommodate a suspension bed that is composed of the brewing liquid and of the solid particles contained in the aroma carriers, and the fluidized bed extractor having at least one inlet and one outlet for the brewing liquid, and wherein the brewing liquid can be pumped from the inlet through the fluidized bed extractor to the outlet with a feed pump, and wherein the feeding speed of the feed pump can be set to a value at which the average vertical feeding speed of the brewing liquid in the fluidized bed extractor is lower than the average vertical sedimentation speed of the solid particles in the fluidized bed extractor.

3. The device according to claim 1, wherein the heater is realized in the manner of a heating element, wherein the suspension of brewing liquid and aroma carriers contained in the fluidized bed extractor can be heated using the heating element.

4. The device according to claim 1, wherein the device comprises a buffer vessel in which the suspension of brewing liquid and aroma carriers can be heated during isomerization and/or after isomerization once the aroma substances have been extracted.

5. The device according to claim 4, wherein the heater is realized in the manner of a flow heater, wherein the suspension can be pumped through the flow heater during heating using a pump and can be heated in flow.

6. The device according to claim 1, wherein the device comprises a cooler for cooling the suspension of brewing liquid and aroma carriers to a cooling temperature below the isomerization temperature after isomerization.

7. The device according to claim 6, wherein the cooler is realized in the manner of a cooling element which is installed on the fluidized bed extractor, or that the cooler is realized in the manner of a flow cooler, wherein the suspension can be pumped through the flow cooler during cooling using a pump and can be cooled in flow.

8. The device according to claim 1, wherein the fluidized bed extractor or the buffer vessel is realized as a pressure vessel in which the suspension of brewing liquid and aroma carriers can be heated under pressure.

9. The device according to claim 1, wherein a mixing element for mixing the suspension of brewing liquid and aroma carriers during isomerization in order to homogenize the temperature distribution is disposed in the fluidized bed extractor or in the buffer vessel.

10. The device according to claim 1, wherein the heater is realized in the manner of a brewhouse vessel, in particular in the manner of a wort kettle, the device comprising a transfer line in which at least part of the suspension of brewing liquid and aroma carriers can be pumped into the brewhouse vessel after the extraction of aroma substances, wherein the suspension of brewing liquid and aroma carriers can be boiled in the brewing vessel together with wort for isomerization.

11. A method for extracting aroma substances from vegetable aroma carriers into a brewing liquid, comprising the following method steps:
a) forming a suspension of the brewing liquid and of the solids contained in the aroma carriers;
b) feeding the brewing liquid through a solids separating device, the vegetable aroma carriers being separated from the brewing liquid in flow and the solids of the aroma carriers being held back in the solids separating device,
wherein
prior to and/or during and/or after release of the aroma substances in the solids separating device, at least part of the suspension of brewing liquid and aroma carriers is heated to an isomerization temperature at which the α-acids contained in the aroma carriers are converted into iso-α-acids.

12. The method according to claim 11, further comprising the following method steps:
a) forming a suspension of the brewing liquid and of the solids contained in the aroma carriers;
b) forming a suspension bed of the brewing liquid and of the solids contained in the aroma carriers in a fluidized bed extractor;
c) feeding the brewing liquid through the fluidized bed extractor at an average vertical feeding speed that is lower than the average vertical sedimentation speed of the solids contained in the aroma carriers so as to release the aroma substances from the solids into the brewing liquid and to separate the solids of the aroma carrier from the brewing liquid;
wherein prior to and/or during and/or after release of the aroma substances in the fluidized bed extractor, at least part of the suspension of brewing liquid and aroma carriers is heated to an isomerization temperature at which the α-acids contained in the aroma carriers are converted into iso-α-acids.

13. The method according to claim 11, wherein after isomerization, the suspension is cooled to a cooling temperature below the isomerization temperature.

14. The method according to claim 11, wherein at least part of the suspension remaining after sufficient release of the aroma substances is pumped into a buffer vessel in which the suspension of brewing liquid and aroma carriers is heated during isomerization and/or cooled after isomerization.

15. The method according to claim 11, wherein the suspension is heated in flow and/or cooled in flow.

16. The method according to claim 11, wherein during isomerization, the suspension is heated under pressure to a temperature greater than 100° C., in particular to a temperature greater than 120° C.

17. The method according to claim 11, wherein during heating for isomerization and/or during cooling after isomerization, the suspension is mixed using a mixing element in order to homogenize the temperature distribution.

18. The method according to claim 11, wherein a hop product, in particular hop pellets, is/are used as the aroma carrier to form the suspension and/or that an alcoholic brewing liquid, in particular fermenting or matured beer, is used to form the suspension.

19. The method according to claim 11, wherein at least part of the suspension remaining after sufficient release of the aroma substances is pumped into a brewhouse vessel, in particular into a wort kettle, the suspension of brewing liquid and aroma carriers being boiled in the brewhouse vessel together with wort for isomerization.
